(19) United States
(12) Patent Application Publication
(10) Pub. No.: US 2015/0134303 A1
(43) Pub. Date: May 14, 2015

(54) THREE-DIMENSIONAL SCANNING SYSTEM AND METHOD WITH HOLE-FILLING FUNCTION FOR POINT CLOUD USING CONTACT PROBE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); Xin-Yuan Wu, Shenzhen (CN); Zong-Tao Yang, Shenzhen (CN)

(21) Appl. No.: 14/485,366

(22) Filed: Sep. 12, 2014

(30) Foreign Application Priority Data
Nov. 12, 2013 (CN) 2013105594529

(51) Int. Cl. G06F 17/50

(52) U.S. Cl. CPC G06F 17/50
USPC 703/1

(57) ABSTRACT

A method for establishing a three-dimensional contour model of an object includes providing a contact probe which has a contact ball and three positioning dots. Then initial positions of the contact ball and positioning dots are established by measuring the contact probe by using a measuring device. A point cloud is created by scanning the object with a three-dimensional non-contact scanner. The contact ball of the contact probe is used to touch the object at a place where a hole of the point cloud is located. Image of the contact probe is caught to calculate out present position of the contact ball. Coordinate of the present position of the contact ball is output as a coordinate for filling the hole of the point cloud.

### CROSS-REFERENCE TO RELATED APPLICATIONS

This application claims priority to Chinese Patent Application No. 201310559452.9 filed on Nov. 12, 2013 in the China Intellectual Property Office, the contents of which are incorporated by reference herein.

### FIELD

The present disclosure relates to three-dimensional scanning technology, and, more particularly to three-dimensional scanning technology which uses a contact probe to make up a deficiency of points for a point cloud to create an accurate and complete contour of a scanned object.

### BACKGROUND

Three-dimensional scanning technology is now useful for a wide variety of applications. This technology is used extensively by the entertainment industry in the production of movies and video games. Other common applications of this technology include industrial design, orthotics and prosthetics, reverse engineering and prototyping, quality control/inspection and documentation of cultural artifacts.

The three-dimensional scanning technology uses a three-dimensional scanner to scan a surface of an object to create a point cloud of geometric samples on the surface of the subject. These points can then be used to extrapolate the shape of the subject (a process called reconstruction). A non-contact active three-dimensional scanner (for example, a triangulation based 3D laser scanner) has advantages that it can more quickly complete the scanning process than a contact three-dimensional scanner. However, the non-contact 3D scanner has its limitations: for a surface which is located in a deep hole or behind another surface, the surface cannot be properly scanned whereby the point cloud created by the scanning will have a discontinuity (hole). Such a discontinuity (hole) lowers the quality of the point cloud and affects the effectiveness of the measurement.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present three-dimensional scanning system and method. Moreover, in the drawings, like reference numerals designate corresponding parts throughout the several views.

FIG. 1 is a block diagram showing a three-dimensional (3D) scanning system in accordance with an embodiment of the present disclosure.

FIG. 2 is a front diagrammatic view of a contact probe of the 3D scanning system of FIG. 1.

FIG. 3 is a block diagram of a hole-filling subsystem of a point cloud using the contact probe of the 3D scanning system of FIG. 1.

FIG. 4 is a diagrammatic view showing a 3D coordinate system created for the contact probe.

FIG. 5 is a flow chart illustrating a method for executing hole filling of the point cloud using the contact probe of the 3D scanning system of FIG. 1.

### DETAILED DESCRIPTION

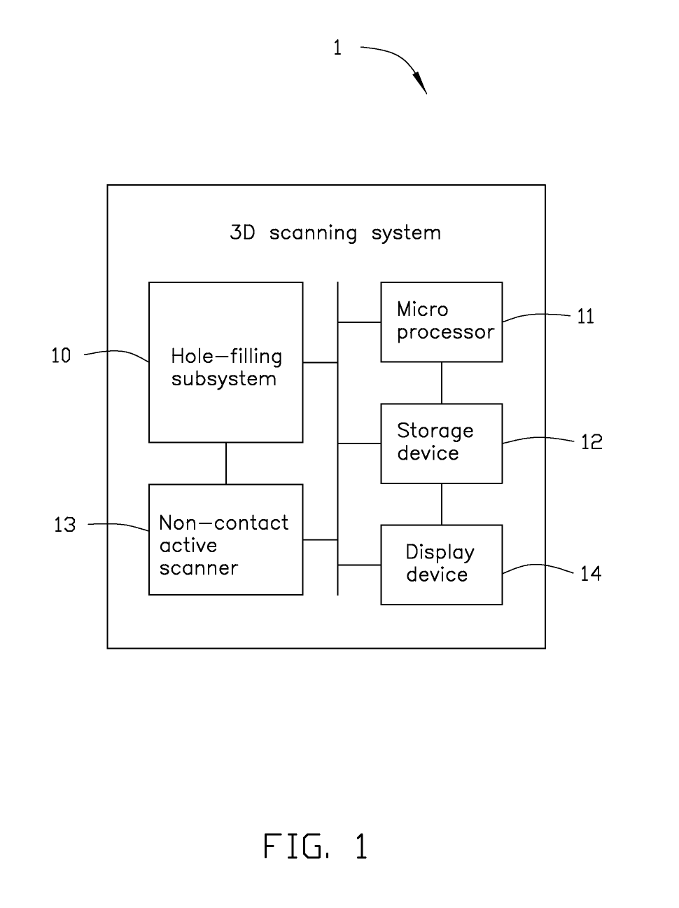

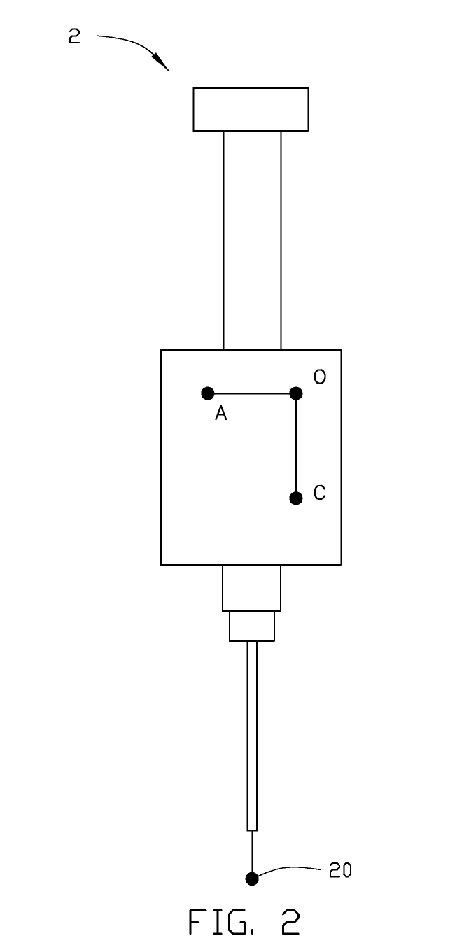

Referring to FIGS. 1 and 2, a three-dimensional (3D) scanning system 1 in accordance with the present disclosure includes a hole-filling subsystem 10 for a point cloud. The 3D scanning system 1 can further have a non-contact active scanner 13 which can be a triangulation based 3D laser scanner consisting of a laser light source and a charge coupled device (CCD). The 3D scanning system 1 further includes a micro processor 11, a storage device 12 and a display device 14. The micro processor 11 is provided for executing software (for example, operating systems) stored in the hole-filling subsystem 10 and the 3D scanning system 1. The storage device 12 can be a hard disc drive (HDD) or other types of information storage equipment, for example, memory card or solid state disc (SSD). The storage device 12 is used for storing a variety of information therein, such as the scanned image information obtained by the scanner 13, and the measured and processed information obtained by the hole-filling subsystem 10. The display device 14 is used for showing the information in visually perceivable manner. The hole-filling subsystem 10 includes a contact probe 2. The scanner 13 scans an object whose surface is to be scanned for creating a point cloud.

The contact probe 2 has a contact ball 20. The contact probe 2 can be a portable contact probe whereby a user can use his (her) hand to hold the contact probe 2 to directly measure a contour of the object by having the ball 20 contact with the surface of the object. Since some parts of the surface cannot be effectively scanned by the light from the scanner 13 due to their hidden positions, position data of these parts of the surface cannot be effectively obtained. The contact probe 2 can be used to probe these parts of the surface of the object to complement the measurement of these hidden parts of the surface to make up the deficiency in the point cloud, wherein such a process is called “hole-filling”.

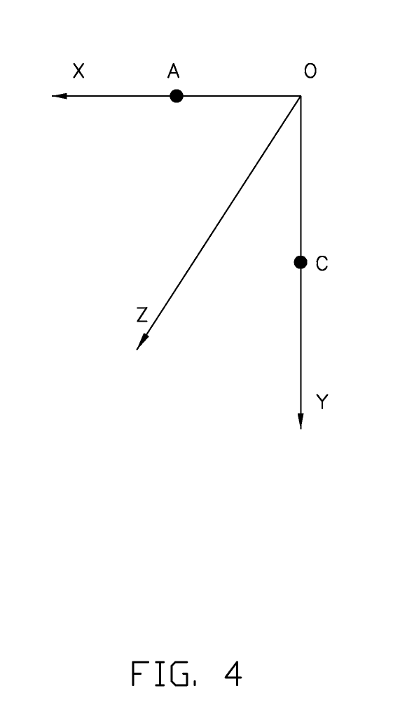

Referring to FIG. 4, in order to properly use the contact probe 2 to proceed with the hole-filling process, it is necessary to create a three-dimensional coordinate system for the contact probe 2. The creation of the three-dimensional coordination for the contact probe 2 can be accomplished by establishing three positioning dots A, O, C on the contact probe 2. The provision of the three positioning dots A, O, C on the contact probe 2 and the photographing of the contact probe 2 by the scanner 13 during the probe and measurement of the contact probe 2 can correctly obtain the measuring positions of the contact ball 20 thereby to make up the voids in the point cloud to obtain the accurate contour of the object which is under measurement.

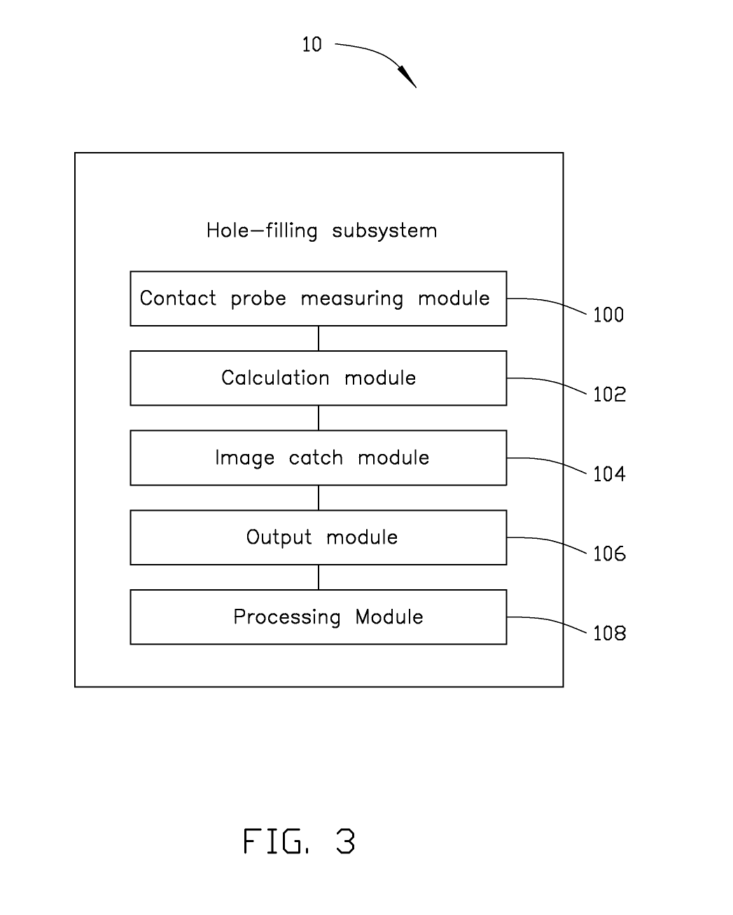

Referring to FIG. 3, the hole-filling subsystem 10 for a point cloud in accordance with the present disclosure includes a contact probe measuring module 100, a calculation module 102, an image catch module 104, an output module 106 and a processing module 108. Functions of the modules 100, 102, 104, 106, 108 will be introduced herebelow, in company with the introduction of the method in accordance with the present disclosure.

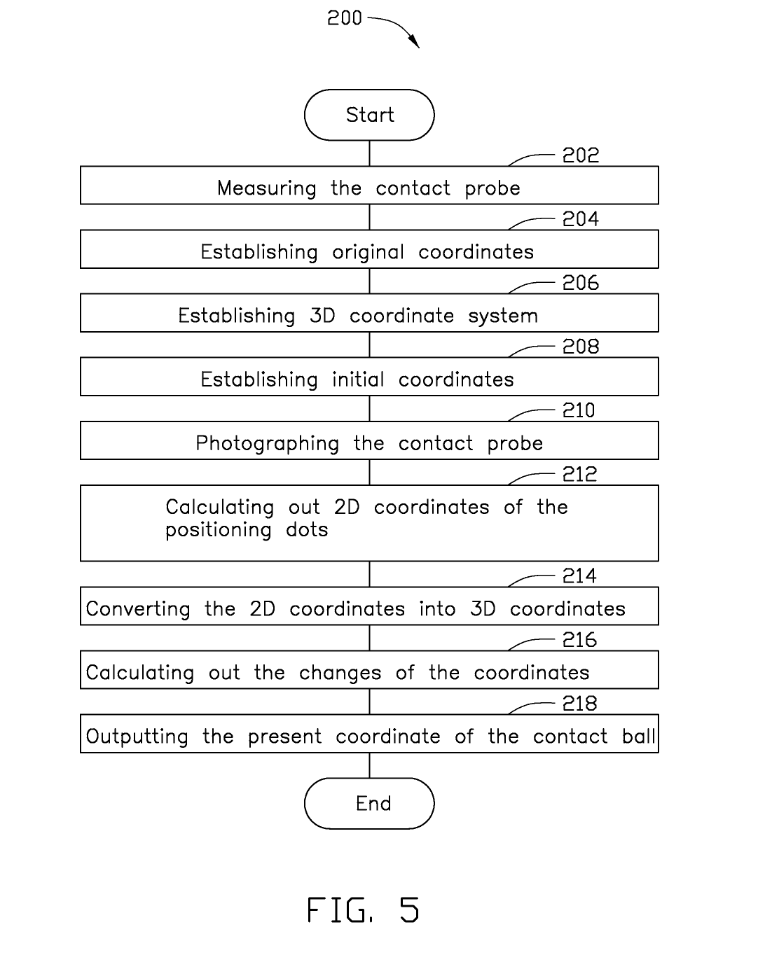

FIG. 5 illustrates a flowchart of an example embodiment of a method for executing the hole filling of the point cloud. The example method 200 is provided by way of example, as there are a variety of ways to carry out the method. The method 200 described below can be carried out using the configurations illustrated in FIGS. 1-4, for example, and various elements of these figures are referenced in explaining example method 200. Each block shown in FIG. 5 represents one or more processes, methods, or subroutines, carried out in the example method 200. Furthermore, the illustrated order of blocks is illustrative only and the order of the blocks can be changed. Additional blocks can be added or fewer blocks may be utilized without departing from this disclosure. The example method 200 can begin at block 202.

In block 202, the contact probe 2 is measured by using a measuring device which can be a three-dimensional measuring device, a three-dimensional scanning device or a three-dimensional image measuring device, separated from the scanner 13 of the 3D scanning system 1 of the present disclosure.

In block 204, the original 3D coordinates of the positioning dots A, O, C are obtained by the contact probe measuring module 100 from the measuring device. The original 3D coordinates of the positioning dots A, O, C can be obtained from the coordinate system of the measuring device.

In block 206, a 3D coordinate system for the contact probe 2 is created by the contact probe measuring module 100 and initial coordinates of the positioning dots A, O, C in the 3D coordinate system of the contact probe 2 are established in accordance with the obtained original coordinates of the positioning dots A, O, C.

Then, in block 208, the initial 3D coordinate of the contact ball 20 of the contact probe 2 is obtained by the calculation module 102.

In block 210, the contact ball 20 of the contact probe 2 is used to measure the hidden parts of the surface of the contour of the object, while the contact probe 2 is photographed by the charge coupled device (CCD) of the scanner 13 to obtain an image of the contact probe 2. The image is stored in the image catch module 104.

In block 212, the two dimensional coordinates of the positioning dots A, O, C in the image are calculated by the calculation module 102.

In block 214, the 2D coordinates of the positioning dots A, O, C are converted into 3D coordinates by the calculation module 102 using a conversion matrix stored in the 3D scanning system 1. The conversion matrix can be a 4*4 matrix.

In block 216, the change of the coordinates of the positioning dots A, O, C from the initial 3D coordinates to the converted 3D coordinates is calculated out by the calculation module 102.

In block 218, the present 3D coordinate of the contact ball 20 of the contact probe 2 is calculated out by the calculation module 102, and the present 3D coordinate is output as a coordinate for the hole-filling of the point cloud by the output module 106. The calculation of the present 3D coordinate of the contact ball 20 is based on the initial 3D coordinate of the contact ball 20 and the change of the 3D coordinates of the positioning dots A, 0 C from the initial 3D coordinates to the converted 3D coordinates thereof.

Referring to FIG. 4, in block 206, the contact probe measuring module 100 first sets up the 3D coordinate system for the contact probe 2. For example, the contact probe measuring module 100 sets up the positioning dot O as an original point of the 3D coordinate system, the direction from O to A as the X-axis direction, and the direction from O to C as the Y-axis direction. Furthermore, based on the X-axis direction and the Y-axis direction, the contact probe measuring module 100 sets up the Z-axis direction of the 3D coordinate system of the contact probe 2. After the setup of the 3D coordinate system of the contact probe 2, the contact probe measuring module 100 transfers the original three-dimensional coordinates of the positioning dots A, O, C into the initial three-dimensional coordinates of the positioning dots A, O, C at the 3D coordinate system of the contact probe 2.

For example, suppose that the original 3D coordinate of positioning dot O is (1, 1, 1,), positioning dot A is (5, 1, 1) and positioning dot C is (1, 5, 1), then when the positioning dot O is setup by the contact probe measuring module 100 to become the original point of the 3D coordinate system of the contact probe 2 which has the initial coordinate of (0, 0, 0), the initial coordinate of the positioning dot A at the 3D coordinate system of the contact probe 2 becomes (4, 0, 0) and the positioning dot C becomes (0, 4, 0).

Alternatively, the contact probe measuring module 100 can directly copy the 3D coordinate system of the measuring device to be as the 3D coordinate system of the contact probe 2 whereby the initial 3D coordinates of the positioning dots A, O, C at the 3D coordinate system of the contact probe 2 are the same as the original 3D coordinates of the positioning dots A, O, C obtained by the measuring device.

There can be an additional block between blocks 208 and 210. The additional block includes using the scanner 13 to scan the object to obtain data of the point cloud by the processing module 108. Alternatively, the additional block can be performed between block 204 and block 206. Then, the data of the point cloud is processed by the processing module 108 obtain a contour surface, and the contour surface is further processed by the processing module 108 to obtain a triangle mesh.

The triangle mesh is obtained by the following manner. A point of the point cloud is arbitrarily chosen as a first point. A point which is nearest to the first point is chosen as a second point, wherein a distance between the first and second points should be smaller than a set value. The first and second points are connected together to establish a line. A third point neighboring the line is identified and the first, second and third points are connected together to establish a triangle. The triangle is checked to decide whether the triangle meets a requirement by the following steps. A circle is created to circumscribe the first, second and third points, wherein the triangle meets the requirement when there is no point other than the first, second and third points in the circle. If there is a point in the circumscribed circle, the processing module 108 will cancel the triangle and choose another third point to create another triangle and repeat the above check step. If there is no point in the circumscribed circle, then an inclusive angle between two normal vectors of the triangle and a neighboring triangle is measured, wherein the triangle meets the requirement when the inclusive angle is smaller than a predetermined value. If the inclusive angle is larger than the predetermined value, the processing module 108 will cancel the triangle and choose another third point to create another triangle and repeat the above two check steps.

The processing module 108, after processing the contour surface of the point cloud by the above described manner, can quickly create the triangle mesh consisting of a plurality of triangles and output the triangle mesh to the display device 14, wherein a user can visually perceive whether the point cloud has any holes which correspond to the parts of the surface of the scanned object which are located in deep holes or blocked by other parts and cannot be properly scanned by the scanner 13.

It is to be understood that the above-described embodiments are intended to illustrate rather than limit the disclosure. Variations may be made to the embodiments without departing from the scope of the disclosure as claimed. The above-described embodiments illustrate the scope of the disclosure but do not restrict the scope of the disclosure.

What is claimed is:

1. A method of hole filling for a point cloud, which is used in a three-dimensional scanning system, the three-dimensional scanning system comprising a non-contact scanner and a contact probe, the method using the contact probe to measure an object to fill a hole of the point cloud of the object obtained by the non-contact scanner, the contact probe having a plurality of positioning dots thereon and a contact ball, the method comprising:
obtaining original three-dimensional coordinates of the positioning dots and the contact ball;
establishing a three-dimensional coordinate system for the contact probe according to the positioning dots thereof;
calculating out initial three-dimensional coordinates of the contact ball and the positioning dots of the contact probe in the three-dimensional coordinate system of the contact probe according to the original three-dimensional coordinates;
moving the contact probe to have the contact ball thereof in contact with a point of a surface of the object;
obtaining an image of the contact ball by the non-contact scanner;
calculating out two-dimensional coordinates of the positioning dots of the contact probe in the image;
converting the two-dimensional coordinates of the positioning dots into three-dimensional coordinates thereof by a converting matrix stored in the scanning system;
comparing the converted three-dimensional coordinates of the positioning dots with the initial three-dimensional coordinates of the positioning dots to find out changes of the coordinates of the positioning dots;
obtaining present three-dimensional coordinate of the contact ball of the contact probe according to the initial three-dimensional coordinate of the contact ball and the changes of the coordinates of the positioning dots; and
outputting the present three-dimensional coordinate of the contact ball as a coordinate for filling a hole in the point cloud.

2. The method of claim 1, wherein the point cloud is obtained by scanning the object by the non-contact scanner before the step of establishing a three-dimensional coordinate system for the contact probe.

3. The method of claim 2, wherein after the point cloud is obtained, a contour surface is established according to the point cloud, and the contour surface is processed to obtain a triangular mesh.

4. The method of claim 3, wherein the processing of the contour surface to obtain the triangular mesh includes:
arbitrarily choosing a point of the point cloud as a first point;
choosing a point which is nearest to the first point as a second point, wherein a distance between the first and second points should be smaller than a set value;
connecting the first and second points to establish a line;
finding a third point neighboring the line and connecting the first, second and third points to establish a triangle; and
checking the triangle to decide whether the triangle meets a requirement, comprising:
circumscribing the first, second and third points to create circle, the triangle meeting the requirement when there is no point other than the first, second and third points in the circle; and
measuring an inclusive angle between two normal vectors of the triangle and a neighboring triangle, the triangle meeting the requirement when the inclusive angle is smaller than a predetermined value.

5. The method of claim 1, wherein the establishment of the three-dimensional coordinate system for the contact probe is made by choosing one of the positioning dots as an original point of the coordinate system and defining directions for X-axis, Y-axis and Z-axis from the original point and the other positioning dots.

6. A hole-filling subsystem for use in a three-dimensional scanning system, the three-dimensional scanning system using a non-contact scanner to scan an object for creating a point cloud for the object, the hole-filling subsystem using a contact probe to measure the object to fill a hole in the point cloud, the contact probe having a plurality of positioning dot thereon and a contact ball, the subsystem comprising:
a contact probe measuring module for establishing a three-dimensional coordinate system for the contact probe in accordance with the positioning dots of the contact probe, and obtaining original three-dimensional coordinates of the positioning dots and the contact ball of the contact probe after measuring the contact probe by a measuring device;
a calculation module for calculating initial three-dimensional coordinates of the positioning dots and the contact ball of the contact probe in the three-dimensional coordinate system of the contact probe according to the original three-dimensional coordinates of positioning dots and the contact ball;
an image obtaining module for capturing an image of the contact probe when the contact probe is used to measure a point of the object, wherein the calculation module is also used to calculate two-dimensional coordinates of the positioning dots in the image and using a converting matrix stored in the scanning system to convert the two-dimensional coordinates into three-dimensional coordinates of the positioning dots, compare the converted three-dimensional coordinates of the positioning dots with the initial three-dimensional coordinates of the positioning dots in the three-dimensional coordinate system of the contact probe, decide changes of the coordinates of the positioning dots by the comparison, and obtain present three-dimensional coordinate of the contact ball in accordance with the initial three-dimensional coordinate of the contact ball and the changes of the coordinates of the positioning dots from the initial three-dimensional coordinates to the converted three-dimensional coordinates thereof; and
an output module for outputting the present three-dimensional coordinate of the contact ball as a coordinate for filling the hole in the point cloud.

7. The hole-filling subsystem of claim 6 further comprising a processing module for obtaining the point cloud of the object and proceeding with the hole-filing of the point cloud according to the present three-dimensional coordinate outputted by the output module.

8. The hole-filling subsystem of claim 7, wherein the processing module obtains the point cloud by using the non-contact scanner to scan the object to obtain data of the point cloud of the object, creates a contour surface according to the data of the point cloud, processes the contour surface to obtain a triangular mesh and outputs the triangular mesh.

9. The hole-filling subsystem of claim 8, wherein the processing module processes the contour surface to obtain the triangular mesh according to following steps:
arbitrarily choosing a point of the point cloud as a first point;
choosing a point which is nearest to the first point as a second point, wherein a distance between the first and second points should be smaller than a set value;
connecting the first and second points to establish a line;
finding a third point neighboring the line and connecting the first, second and third points to establish a triangle; and
checking the triangle to decide whether the triangle meets a requirement, comprising:
circumscribing the first, second and third points to create circle, the triangle meeting the requirement when there is no point other than the first, second and third points in the circle; and
measuring an inclusive angle between two normal vectors of the triangle and a neighboring triangle, the triangle meeting the requirement when the inclusive angle is smaller than a predetermined value.

10. The hole-filling subsystem of claim 6, wherein the measuring device is one of a three-dimension measuring device and a three-dimension scanning device.

11. A method of hole filling for a point cloud in a three-dimensional scanning system having a non-contact scanner and a contact probe having a plurality of positioning dots thereon and a contact ball comprising:
measuring, by the contact probe, an object to fill a hole of the point cloud obtained by a non-contact scanner;
obtaining an original set of three-dimensional coordinates of the positioning dots and the contact ball of the contact probe;
creating a three-dimensional coordinate system for the contact probe according to the positioning dots thereon;
calculating an initial set of three-dimensional coordinates of the contact ball and the positioning dots of the contact probe in the three-dimensional coordinate system of the contact probe according to the original three-dimensional coordinates;
repositioning the contact probe so that the contact ball is in contact with a surface of the object;
obtaining an image of the contact ball by the non-contact scanner;
calculating a set of two-dimensional coordinates of the positioning dots of the contact probe in the image;
converting the set of two-dimensional coordinates of the positioning dots into a set of converted three-dimensional coordinates thereof by a conversion matrix stored in the three-dimensional scanning system;
comparing the set of converted three-dimensional coordinates of the positioning dots with the initial set of three-dimensional coordinates of the positioning dots to determine a change in the in coordinates of the positioning dots;
obtaining a present set of three-dimensional coordinates of the contact ball according to the initial set of three-dimensional coordinates of the contact ball and the change in coordinates of the positioning dots; and
outputting the present set of three-dimensional coordinates of the contact ball as a coordinate for filling a hole in the point cloud.
